(19) United States
(12) Patent Application Publication
(10) Pub. No.: US 2003/0188950 A1
(43) Pub. Date: Oct. 9, 2003

(54) Multiplate clutch

(75) Inventors: Yoshio Kinoshita, Shizuoka-ken (JP); Hirofumi Nakagomi, Tokyo (JP)

Correspondence Address: CROWELL & MORING LLP, P.O. Box 14300, Washington, DC, 20044-4300, US

(73) Assignee: NSK-WARNER K.K.

(21) Appl. No.: 10/406,220

(22) Filed: Apr. 4, 2003

(30) Foreign Application Priority Data
Apr. 5, 2002 (JP) 2002-103579

(51) Int. Cl. F16D 13/68

(52) U.S. Cl. 192/109 R; 192/70.2; 192/85 AA

(57) ABSTRACT

A multiplate clutch has a stopper ring arranged at an opening of a clutch case to limit axial movements of frictionally engaging elements such as separator plates, friction plates and a backing plate. Among these frictionally engaging elements, the backing plate which is operably brought into engagement with the stopper ring is provided on a stopper-ring-engaging wall thereof with a stopper portion to support the stopper ring at an inner periphery thereof.

### BACKGROUND OF THE INVENTION

a) Field of the Invention

This invention relates to a multiplate clutch for use in mechanical transmission of power.

b) Description of the Related Art

Using FIG. 7 which shows one embodiment of the present invention in cross-section, the basic construction of an exemplary multiplate clutch will be described. The multiplate clutch, which is illustrated as a hydraulic multiplate clutch and is generally designated at numeral 10, has a clutch case 1, and is provided with separator plates 21, friction plates 22, a backing plate 3 and the like arranged as frictionally engaging elements inside the clutch case 1. These fictionally engaging elements are designated as a whole at numeral 2 in FIG. 7. The frictionally engaging elements 2 are pressed by a piston 4 toward an opening of the clutch case 1. As a consequence, the backing plate 3 located at a rightmost position is brought into engagement with a stopper ring 5 which is fitted in a groove 52 (see FIG. 11) formed in an inner peripheral wall of the clutch case 1. Between the backing plate 3 and the piston 4, the remaining frictionally engaging elements, i.e., the separator plates 21 and the friction plates 22 are hence brought into contact under pressure, so that power is transmitted to a counterpart member (not shown) via splined connection on the side of inner peripheries of the friction plates 22.

When a hydraulic pressure is introduced into a left-hand oil compartment 6, the piston 4 is pressed rightward so that the piston 4 presses the frictional engaging elements 2 toward the stopper ring 5. Disengagement of the clutch is effected by drawing the hydraulic pressure from the oil compartment 6 and pressing back the piston 4 leftward by a return spring 7. Centrifugal hydraulic pressure which is produced within the oil compartment 6 is cancelled out by centrifugal hydraulic pressure from a canceller 81.

FIG. 11 is a fragmentary cross-sectional view of the conventional multiplate clutch, in which the backing plate 3 and the stopper ring 5 are in engagement with each other. FIG. 12 is a front view of the stopper ring 5, which is provided with an open or broken part 51. Upon attachment to the clutch case 1, the stopper ring 5 is fitted into the groove 52 formed in the inner peripheral wall of the clutch case 1 while holding the open or broken part 51 narrower. Designated at numeral 32 is a stepped portion formed on the backing plate 3 to avoid any interference with the stopper ring upon fitting the stopper ring. Further, numeral 33 indicates a spline formed on an outer periphery of the backing plate 3, and this spline 33 is connected with a spline groove 11 formed in the inner peripheral wall of the clutch case 1.

The frictionally engaging elements, including the backing plate, are pressed against the stopper ring under pressing force from the piston as described above. The backing plate, however, is caused to move up and down while being pressed against the stopper ring, because the multiplate clutch is subject to vibrations due to operation of an engine and also to vibrations from axes during running. By frictional force between the backing plate and the stopper ring, the stopper ring is then pulled inward and may come off. It is, therefore, necessary to take a measure for the prevention of the stopper ring from coming out of the groove. Preferably, the attachment of the stopper should not be rendered difficult or otherwise inconvenienced by such a measure.

### SUMMARY OF THE INVENTION

An object of the present invention is, therefore, to provide a multiplate clutch in which a stopper ring is preventing from coming out of a groove formed in an inner peripheral wall of a clutch case preferably while permitting easy fitting of the stopper ring in the groove.

In one aspect of the present invention, there is thus provided a multiplate clutch having a stopper ring arranged at an opening of a clutch case to limit axial movements of frictionally engaging elements including separator plates, friction plates and a backing plate. Among the frictionally engaging elements, the backing plate which is operably brought into engagement with the stopper ring is provided on a stopper-ring-engaging wall thereof with a stopper portion to support the stopper ring at an inner periphery thereof.

Owing to the above-described construction, the stopper ring is supported on the inner periphery thereof by the stopper portion formed on the backing plate. Therefore, the stopper ring is prevented from coming out during operation, and moreover, the stopper portion does not make difficult the attachment of the stopper ring.

### BRIEF DESCRIPTION OF THE DRAWINGS

FIG. 1 is a fragmentary cross-sectional view taken along line O-I of FIG. 2, and FIG. 1 is similar to FIG. 11 and illustrates a positional relationship between a backing plate and a stopper ring in a first embodiment of the present invention.

FIG. 2 is a front view of the backing plate in FIG. 1.

FIG. 3 is a fragmentary cross-sectional view taken along line O-III of FIG. 4, and FIG. 3 is similar to FIGS. 1 and 11 and illustrates a positional relationship between a backing plate and a stopper ring in a second embodiment of the present invention.

FIG. 4 is a front view of the backing plate in FIG. 3.

FIG. 5 is a fragmentary cross-sectional view taken along line O-V of FIG. 6, and FIG. 5 is similar to FIGS. 1, 3 and 11 and illustrates a positional relationship between a backing plate and a stopper ring in a second embodiment of the present invention.

FIG. 6 is a front view of the backing plate in FIG. 5.

FIG. 7 is a fragmentary cross-sectional view of a multiplate clutch to which the first embodiment of the present invention has been applied.

FIG. 8 is a fragmentary cross-sectional view similar to FIG. 1, and illustrates a dimensional relationship between the stopper ring and a groove for the stopper ring as set such that the stopper ring is rendered more difficult to come off.

FIG. 9 is a fragmentary cross-sectional view similar to FIG. 8, and illustrates a dimensional relationship between the stopper ring and a stopper portion as set such that the attachment of the stopper ring is facilitated.

FIG. 10 is a fragmentary cross-sectional view similar to FIGS. 8 and 9, and illustrates the manner of attachment of the stopper ring.

FIG. 11 is a fragmentary cross-sectional view showing a relationship between a backing plate and a stopper ring in a conventional multiplate clutch.

FIG. 12 is a front view of the stopper ring in the conventional multiplate clutch of FIG. 11.

### DETAILED DESCRIPTION OF THE INVENTION AND PREFERRED EMBODIMENTS

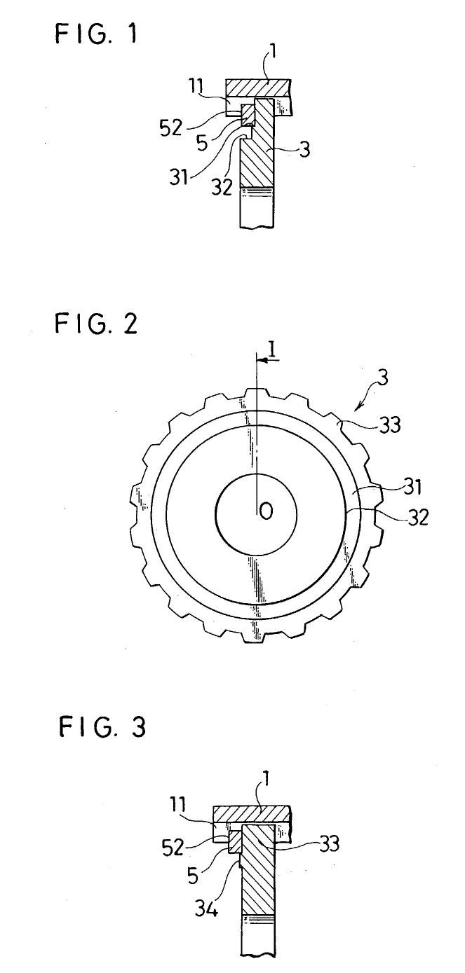

As illustrated in FIGS. 1 and 7, the present invention features the provision of a small step on a stopper-ring-engaging wall of a backing plate such that a stopper portion is formed to support a stopper ring at its inner periphery.

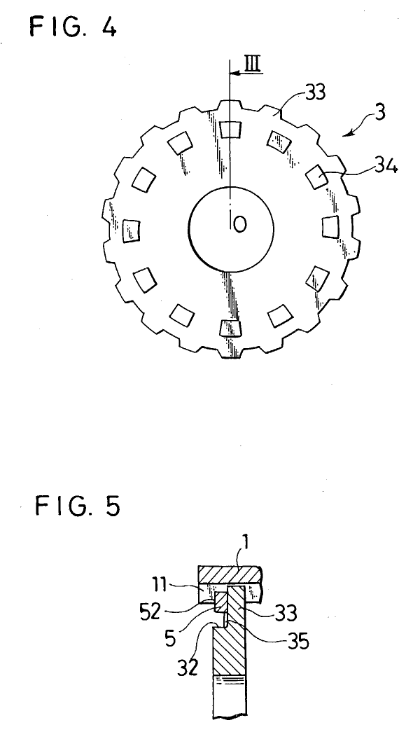

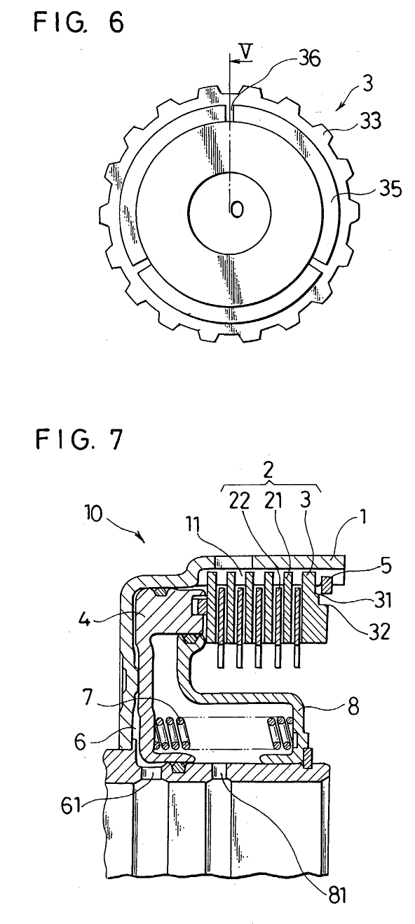

The stopper portion is not limited to the above-mentioned form, but the stopper portion can take any form insofar as it can support the stopper ring at its inner periphery and does not give any inconvenience or problem upon attachment of the stopper ring. For example, the stopper portion can be in the form of plural low convexities arranged in the pattern of a circle corresponding to the inner periphery of the stopper ring as depicted in FIGS. 3 and 4, or can be formed of an annular land portion with at least one, preferably two or three radial slots formed therein as illustrated in FIGS. 5 and 6.

Referring first to FIGS. 1 and 2, the multiplate clutch according to the first embodiment of the present invention will be described. The relationship between the backing plate 3 and the stopper ring 5 is similar to that of the conventional example described above with reference to FIG. 11. In FIGS. 1 and 2 and FIG. 11, like elements of structure are designated by like reference numerals, respectively. In the first embodiment, the backing plate 3 is provided on its stopper-ring-engaging wall with the stepped portion 31 constructed of a step portion which supports the stopper ring 5 on its inner periphery. Owing to this construction, the stopper portion 31 can prevent the stopper ring 5 from moving inward even when upon engagement of the clutch, the backing plate 3 is pressed against the stopper ring 5 and subjected to vibrations and hence becomes about to be dragged inward by frictional force. Accordingly, the stopper ring 5 does not come out of the groove 52. Designated at numeral 33 are splines formed on the outer periphery of the backing plate 3.

Referring next to FIGS. 3 and 4, the multiplate clutch according to the second embodiment of the present invention will be described. A backing plate 3 is provided with a plurality of low convexties 34 arranged in the pattern of a circle, which corresponds to an inner periphery of a stopper ring 5.

Referring further to FIGS. 5 and 6, the multiplate clutch according to the third embodiment of the present invention will be described. A stopper portion is constructed of an annular land portion 35 with three radial slots 36 formed therein.

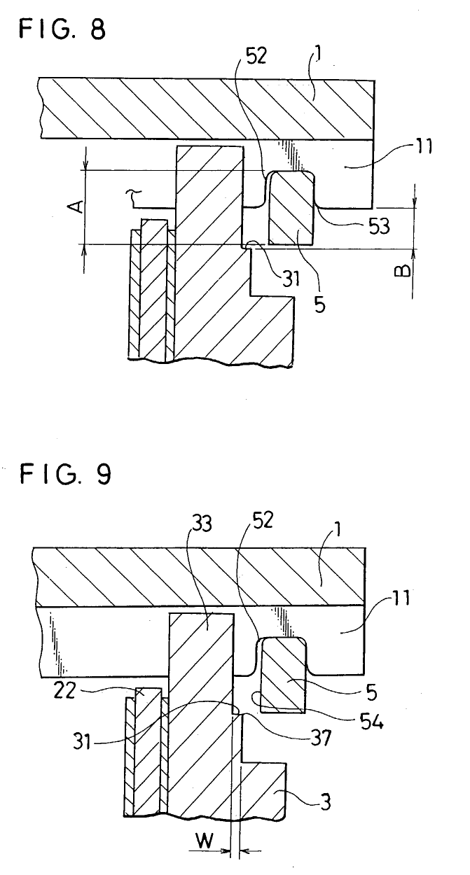

FIG. 8 illustrates an example in which a stopper ring 5 is constructed to be more difficult to come off. This example is constructed to satisfy the following inequality:

A<B

where

A: the radial cross-sectional dimension of the stopper ring 5, and

B: the distance from an edge portion 53 of the groove 52 for the stopper ring 5, that is, the inner peripheral wall of the cylinder case 1 to the stopper portion 31.

Reference is next had to FIG. 9. The height (i.e., the axial width) W of the stopper portion 31 is set such that, in a state that the piston 4 has been brought to the rearmost position thereof, the friction plates 22, separator plates 21 and backing plate 3 have all been brought toward the piston 4 and the stopper ring 5 has been brought to a side most apart from the piston 4 in the groove 52 for the stopper ring 5, a radial piston-side wall 54 of the stopper ring 5 is located on a side more apart from the piston 4 than a corner portion 37 of the stopper portion 31 (see FIG. 7 and FIG. 9 in combination)

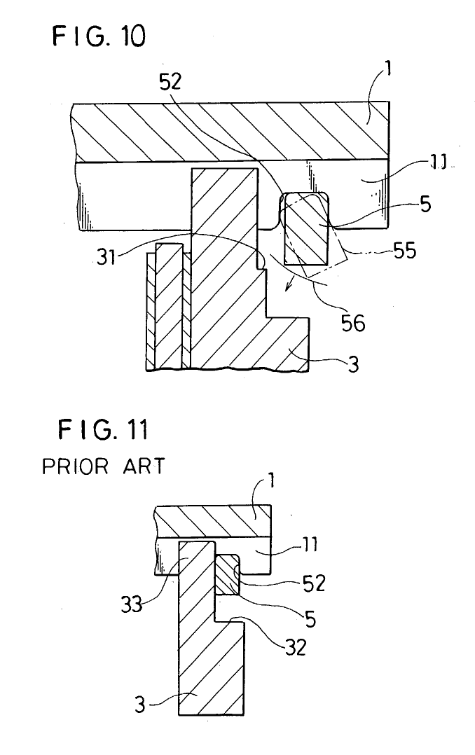

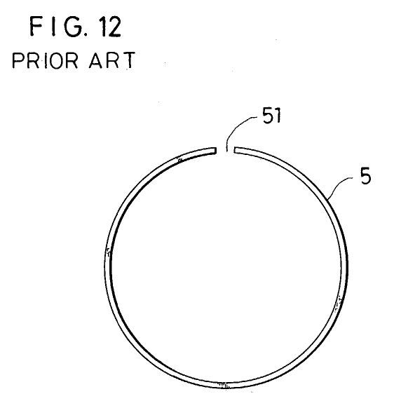

Reference is made further to FIG. 10 to describe the manner of attachment of the stopper ring 5. With the piston 4 having been brought to its rearmost position and the friction plates 22, separator plates 21 and backing plate 3 having all been brought toward the piston 4 as in the case of FIG. 9, and further with the stopper ring 5 being held in an inclined position as indicated by dashed lines 55, the stopper ring 5 is inserted at an outer circumferential portion thereof into the groove 52 for the stopper ring 5 and is then fitted, while undergoing plastic deformation, into the groove 52 for the stopper ring 5 from the inserted position until the stopper ring 5 is brought into a position perpendicular to an axial direction. During this attachment, the stopper portion 31 is located on an inner side of a locus 56 drawn by an innermost side edge of the stopper ring 5.

By constructing a multiplate clutch as described above with reference to FIGS. 8, 9 and 10, the attachment of a stopper ring is facilitated even when friction plates, separator plates and the like have already been arranged in a clutch case upon assembling the multiplate clutch. Moreover, the stopper ring so attached is more difficult to come off.

The expression “with the piston having been brought to its rearmost position and the friction plates, separator plates and backing plate having all been brought toward the piston” as used herein indicates a situation that, where a resilient member (a spring such as a wave spring ora leaf spring) is interposed between the pressing wall of the piston and the frictionally engaging elements in FIG. 7, the resilient member has been fully flexed in the direction that the frictionally engaging elements are being pressed toward the piston”.

Each of the second embodiment shown in FIGS. 3 and 4 and the third embodiment depicted in FIGS. 5 and 6 can also bring about similar advantageous effects when the dimensional relationship between the stopper ring and the groove for the stopper ring and the dimensional relationship between the stopper ring and the stopper portion are set as described above.

This application claims the priority of Japanese Patent Application 2002-103579 filed Apr. 5, 2002, which is incorporated herein by reference.

What is claimed is:

1. A multiplate clutch having a stopper ring arranged at an opening of a clutch case to limit axial movements of frictionally engaging elements including separator plates, friction plates and a backing plate, wherein among said frictionally engaging elements, said backing plate which is operably brought into engagement with said stopper ring is provided on a stopper-ring-engaging wall thereof with a stopper portion to support said stopper ring at an inner periphery thereof.

2. A multiplate clutch according to claim 1, wherein said stopper portion is a stepped portion.

3. A multiplate clutch according to claim 1, wherein said stopper portion comprises a plurality of low convexties arranged in a circular pattern.

4. A multiplate clutch according to claim 1, wherein said stopper portion is an annular land portion with at least one radial slot formed therein.

5. A multiplate clutch according to claim 1, wherein said stopper ring is fitted in a groove formed in an inner peripheral wall of said clutch case, and a distance from said inner peripheral wall of said clutch case to said stopper portion is smaller than a radial cross-sectional dimension of said stopper ring.

6. A multiplate clutch according to claim 5, wherein said multiplate clutch is constructed such that, when with a piston having been brought to a rearmost position thereof, with said friction plates, separator plates and backing plate having all been brought toward said piston and with said stopper ring being held in an inclined position, said stopper ring is inserted at an outer circumferential portion thereof into said groove for said stopper ring and is then fitted, while undergoing plastic deformation, into said groove for said stopper ring from said inserted position until said stopper ring is brought into a position perpendicular to an axial direction, said stopper portion is located on an inner side of a locus drawn by an innermost side edge of said stopper ring.

7. A multiplate clutch according to claim 5, wherein an axial width of said stopper portion is set such that, in a state that a piston has been brought to a rearmost position thereof, said friction plates, separator plates and backing plate have all been brought toward said piston and said stopper ring has been brought to a side most apart from said piston in said groove for said stopper ring, a radial piston-side wall of said stopper ring is located on a side more apart from said piston than a corner portion of said stopper portion.

8. A multiplate clutch according to claim 7, wherein said multiplate clutch is constructed such that, when with said piston having been brought to a rearmost position thereof, with said friction plates, separator plates and backing plate having all been brought toward said piston and with said stopper ring being held in an inclined position, said stopper ring is inserted at an outer circumferential portion thereof into said groove for said stopper ring and is then fitted, while undergoing plastic deformation, into said groove for said stopper ring from said inserted position until said stopper ring is brought into a position perpendicular to an axial direction, said stopper portion is located on an inner side of a locus drawn by an innermost side edge of said stopper ring.
